(19) United States
(12) Patent Application Publication
(10) Pub. No.: US 2008/0125329 A1
(43) Pub. Date: May 29, 2008

(54) Geometrical filters for microarray assays

(76) Inventor: Hassan M. Fathallah-Shaykh, Chicago, IL (US)

Correspondence Address: WELSH & KATZ, LTD, 120 S RIVERSIDE PLAZA, 22ND FLOOR, CHICAGO, IL, 60606, US

(21) Appl. No.: 11/897,869

(22) Filed: Aug. 31, 2007

Related U.S. Application Data
(60) Provisional application No. 60/842,053, filed on Aug. 31, 2006.

(51) Int. Cl. C40B 30/10

(52) U.S. Cl. 506/12

(57) ABSTRACT

A method of improving the sensitivity and selectivity of dye swapping cDNA microarray assays includes providing replicate expression data, preferably in the form of fluorescence measurements of two dyes. The replicate expression data can be ranked based on the intensity of fluorescence from the each of the dyes to generate first and second spot order rankings for each expression datum. A three-dimensional framework can be established that has indices of first spot order ranking, second spot order ranking, and the fluorescence intensity of a sample relative to that of a reference genetic material.

An upper surface and a lower surface can be defined in the three dimensional framework containing between them a noise region, the noise region containing replicate expression data that have been determined as being probable noise according to predetermined parameters. These noise data can then be removed from the replicate expression data that lies in the probable noise region of the three dimensional framework to produce data having a predetermined significance level.

### CROSS-REFERENCE TO RELATED APPLICATIONS

This application claims the benefit of U.S. Provisional Application No. 60/842,053, filed Aug. 31, 2006.

### REFERENCE TO PROGRAM LISTINGS

A computer program listing appendix has been submitted on compact disc for this disclosure. The material on that compact disc is incorporated by reference herein. The compact disc was filed with 2 copies, and contains the following filed with:

| NAME OF FILE | DATE OF CREATION | SIZE IN BYTES |
|---|---|---|
| FSWORD.TXT | Aug. 31, 2007 | 24,487 |
| INSTRUCTIONS.TXT | Aug. 31, 2007 | 6,148 |

### INCORPORATION-BY-REFERENCE OF MATERIAL SUBMITTED ON A COMPACT DISC

Exemplary mathematical analysis is performed using functions written in Matlab (Mathworks, Natick, Mass.). The exemplary program Fs is freely available to academics for noncommercial use.

### BACKGROUND OF THE INVENTION

1. Field of the Invention

The invention relates to systems and methods for profiling states of genetic expression using gene microarrays. Specifically, the invention relates to improving the sensitivity of profiling algorithms that yields highly specific states of genetic expression (up or down regulation) from the genome-scale profiling of two samples.

2. Background Art

The cells of living things contain sets of chromosomes each which are made up of identical genes. However, more complicated plants and animals can have a variety of different types of cells. For example, people have different types of cells to serve as heart muscle than are used to make up skin.

Since cells have different functions, only a fraction of the genes in a cell are “turned on” or “expressed” to give each cell type its unique character to carry out it a function. Genes are expressed in a cell by taking the information from the DNA in a gene and making messenger RNA (mRNA) in a process that is called “transcription.” Messenger RNA molecules are then translated into the proteins that perform the actual functions inside the cells.

Scientists study the kinds and amounts of mRNA produced by a cell to learn which genes are expressed. Gene expression is a complex and tightly regulated process by which a cell responds to its environment and to its own changing needs.

The gene expression mechanism can act in two ways—it can act as an “on/off” switch to control which genes are expressed in a cell as well as a “volume control” that increases or decreases the level of expression of particular genes as necessary.

DNA microarray technology facilitates the identification and classification of DNA sequence information and the assignment of functions to these genes. A microarray works by using the ability of a given mRNA molecule to bind specifically to, or hybridize with, the DNA template from which it was transcribed. By using an array containing many DNA samples, scientists can determine, in a single experiment, the expression levels of hundreds or thousands of genes within a cell by measuring the amount of mRNA bound to each DNA sequence on the array. With the aid of a computer, the amount of mRNA bound to the spots on the microarray can be measured, providing insight into the gene expression of the cell.

The genomes of several organisms have recently been sequenced and the enthusiasm about the potential of microarrays has been intense (Schena et al., 1995; Lockhart et al., 1996; DeRisi et al. 1997). Microarray studies are increasingly being used to explore biological causes and effects and even to diagnose diseases. However, the data from microarrays are very noisy and the patterns of expression and molecular signatures of microarrays have problems with reproducibility (Kothapalli et al., 2002; Ntzani and Ioannidis, 2003; Tan et al., 2003).

MASH is a mathematical algorithm that yields highly specific states of genetic expression (up- or down-regulation) from the genome-scale profiling of two samples (Fathallah-Shaykh et al. 2004). The term ‘highly specific’ refers to the high specificity of states of genetic expression discovered by MASH. Specifically, the false positive rates of MASH and the Microarray Data Analysis System (“MIDAS”) (available from The Institute for Genomic Research at www.tm4.org) in same-to-same comparisons using the 19K microarrays have been found to be 1/192,000 and 1,347/192,000 measurements, respectively. Accordingly, MASH specificity can be significantly better, yet have sensitivity equal to MIDAS.

It would be desirable to achieve a better understanding of the noise that gene microarrays are subject to, and to develop new methods that significantly improve the sensitivity of methods that profile two samples without lowering specificity. Those skilled in the art will keep in mind that sensitivity is not only dependent on the analytical method applied, but also on the quality of the dataset (Fathallah-Shaykh et al., 2004).

### BRIEF SUMMARY OF THE INVENTION

A method of improving the sensitivity and selectivity of dye swapping cDNA microarray assays comprising:

providing replicate expression data for sample genetic material and reference genetic material for a plurality of probe genetic materials, the replicate expression data comprising intensities of fluorescence from a first dye and a second dye, the replicate expression data comprising a first set of fluorescence measurements having the first dye labeling the sample genetic material and the second dye labeling the reference genetic material, and the replicate expression data comprising a second set of fluorescence measurements having the second dye labeling the sample genetic material and the first dye labeling the reference genetic material;

ranking the replicate expression data based on the intensity of fluorescence from the first dye to generate a first spot order ranking for each expression datum;

ranking the replicate expression data based on the intensity of fluorescence from the second dye to generate a second spot order ranking for each expression datum;

establishing a three-dimensional framework that has indices of first spot order ranking, second spot order ranking, and the ratio of the fluorescence intensity of the dye labeling the sample genetic material to the fluorescence intensity of the dye labeling the reference genetic material;

predetermining a level of significance for final result;

establishing an upper surface and a lower surface in the three dimensional framework containing between them a noise region in the three dimensional framework, the noise region containing replicate expression data that have been determined as being probable noise;

removing from the replicate expression data that lies in the probable noise region of the three dimensional framework to produce data having the predetermined significance level.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

FIG. 1 are scatter plots showing the dataset-specific geometry and the geometrical distributions of f4-sensitive spots along with the distribution of all the spots. Blue and green correspond to the data of the dye swapping experiments.

(a) and (d) plot the log 2(ratios) of all spots of 19K same-to-same and 1.7K same-to-same datasets, respectively.

(b) and (e) plot the F1-resistant spots of (a) and (d), respectively.

(c) and (f) plot the log 2(ratios) of the f4-sensitive spots of (a) and (d), respectively.

The geometrical distributions of (c) and (f) replicate those of (a) and (d), respectively.

FIG. 2 is a plot of the zone of instability using the same dataset as the one shown in FIG. 1a-c.

(a) is a plot of the log 2(ratios), y-axis, versus ranks in SO1. In (a) the spots whose ranks in SO2 are within the following intervals, [1, 3000[, [3000, 6000[, [6000, 10000[, [10000, 12500[, [12500, 15000[, [15000, 17500[, and [17500, 19200[, are colored in blue, red, black, green, magenta, yellow, and cyan, respectively.

(b) is a plot of the log 2(ratios), y-axis, versus ranks in SO2. In (b) the spots whose ranks in SO1 are within the following intervals, [1, 3000[, [3000, 6000[, [6000, 10000[, [10000, 12500[, [12500, 15000[, [15000, 17500[, and [17500, 19200[, are colored in blue, red, black, green, magenta, yellow, and cyan, respectively. Black arrows point to the CR. 30 Red arrows point to log 2 (ratios) whose absolute values are large (large errors) 40.

(c) and (d) plot the F1-resistant spots of (a) and (b), respectively. Each 19K array includes two slides, P1 and P2. (e) plots the standard deviations of F1-resistant (green) and F1-sensitive (blue) log 2 (ratios) of the datasets of either P1 or P2.

FIG. 3 shows the geometrical distribution of different-to-different datasets.

(a) plots the log 2 (ratios) of all spots from the profiling of a meningioma RNA versus normal brain using the 19K microarrays. The space is defined by the ranks in SO1, x-axis, ranks in SO2, y-axis, and log 2 (ratios), z-axis. Black arrows point to the variability of log 2 (ratios) at different ranks. Red arrows point to large measurements generated by log 2 (ratios), whose absolute values are large. Blue and green correspond to the data of the dye swapping experiments.

(b) plots the F1-resistant spots of (a).

(c) plots the log 2 (ratios) of the f4-sensitive spots of (a). Black and red correspond to the data of the dye swapping experiments.

FIG. 4 shows the results of computing the upper and lower limits of noise at every spot in the datasets. (a)-(e) are cartoons that illustrate the construction of upper and lower bound surfaces. For every spot k of coordinates (xk, yk, zk) in the space G, defined by all the spots of the dataset (a, yellow), the algorithm constructs a square column, Ck, in the space G4 of its f4-sensitive spots (b-d) such that (1) the columns are parallel to the z-axis, and (2) the square is centered at the spot (xk, yk, zk).

The cyan lines of (b) and (c) are located at the four corners of the square column. The algorithm isolates the log 2 (ratios) within the square column Ck to compute the μₚ, μₙ, and sd (d). The coordinates of the upper and lower limits at spot k are (xp, yp, mp+n*sd) and (xk, yk, mn+n*sd), respectively. The term n is a variable.

The background data in (a) is the same dataset shown in FIG. 3a, and the background data in (b) plots the f4-sensitive noise of (a) (FIG. 3c).

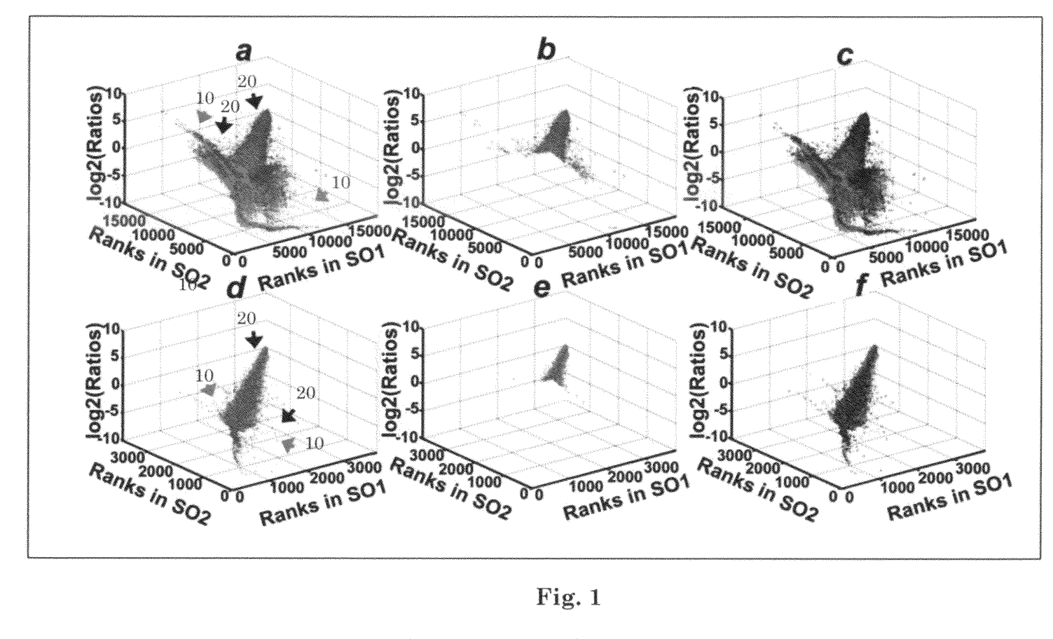

FIG. 5 shows how Fs constructs noise- and rank-dependent contour surfaces. The upperbound contour surface (green to red) is constructed by connecting all the upper bound limits generated by Fs (see cartoon of FIG. 4e). The lower bound contour surface (green to blue) is constructed by connecting all the lower bound limits generated by Fs (see cartoon of FIG. 4e). (a), (c) and (e) are wireframe mesh plots of the lower (green to blue) and upper-bound (green to red) contour surfaces of the datasets of FIGS. 1a, 1d and 3a, respectively. (b), (d), and (f) show different views of (a), (c), and (e), respectively. Arrows 50 point to large-axis coordinates of the contour surfaces over the zone of instability.

FIG. 6 shows how Fs significantly enhances sensitivity without lowering the high specificity of MASH.

(a) and (b) show the effects of varying n on the false discovery rates of Fs in the analysis of 10 same-to-same 19K and 9 same-to-same 1.7K comparisons, respectively.

(c) shows the effects of varying n and adding F1 to Fs on the percent discovery of Arabidopsis genes from the best of four 1.7K spike-in experiments, where 1 ng Arabidopsis RNA is added to one sample but not the other.

In (c) n is varied in the interval [2,6] and either Fs or F1+Fs are applied and compared with MASH (black).

(d) shows the sensitivity of MASH (first of each series) and Fs at n=2-4, in ascending half n increments, in all four 1.7K spike-in experiments, where 1 ng Arabidopsis RNA is added to one sample but not the other. As compared with MASH, the increase in sensitivity of Fs at n=3 is statistically significant (balanced one-way ANOVA, P=0).

FIG. 7 is a flow chart showing one implementation of the methodology of the present invention.

### DETAILED DESCRIPTION OF THE INVENTION

To make the exemplary embodiment outlined in this application clearer, the terms ‘genes’, ‘spots’, ‘symmetrical’, ‘rank’, and ‘spot order’ are exemplified in using a commercially available 1.7K array as an example. However, the terms as defined in the example are also applicable to other microarrays.

Gene microarrays are slides, usually made of glass, with areas on the slide that have been created with genetic material attached to the area. A location where the genetic material is placed on the slide is called a ‘spot.’ The exemplary 1.7K microarray contains 1920 cDNAs, here referred to as ‘genes.’ are placed twice each on a given slide to a total of 3840 ‘spots.’

The RNA on the spot is referred to as the ‘probe’ RNA being used to determine what RNA is present in the sample being put on the slide. In the examples that follow, human brain RNA is the sample, but the processes described can be applied to any RNA experiment if the same principles are applied. Similarly, the degree of neurological disease expressed by the human brain RNA is being tested, but other results of gene expression are equally subject to the methods disclosed here.

For convenience, each slide contains two replicate adjacent spots for each gene. The samples used in the experiment, the RNA that is introduced to the slides, is labeled with dyes. When the sample RNA is placed on the spot, if the sample RNA links up with the gene it is said to have “hybridized” with the gene. After the sample has been hybridized to the microarray, loose sample is washed off. Accordingly, the amount of fluorescence on a given spot correlates with the amount of sample material that has hybridized with the genetic material on that spot.

For each sample, two different dyes are usually used, in the examples given here Cy3 and Cy5, but other dyes could be used. Because there are two of each gene, the term symmetrical refers to the two patterns (or images when lit), corresponding to the same sample labeled with each of Cy3 and Cy5 fluorescent dyes, on a single microarray slide. Dye swapping refers to experiments where the Cy3 and Cy5 dyes are reversed between the two samples; they are performed to annul confounding variables introduced by heterogeneous fluorescence of the Cy5 and Cy3 molecules. Each microarray slide yields of a set of symmetrical Cy3/Cy5 images that generate two replicate ratios. Each dye swapping dataset generates four replicate ratios. This simplifies the execution of swapping Cy3 and Cy5 to obtain two ratios. The total is four replicate ratios with dye-swapping. RNA used in spike-in experiments is transcribed from the same Arabidopsis cDNA spotted on microarray slides.

The design of the exemplary gene microarray experiment, which includes dye swapping as that term is used in the literature, generates four replicate measurements per gene and sample is described more fully in Fathallah-Shaykh et al., 2003, 2002, which is incorporated by reference as if fully set forth herein. The amount of light from the fluorescent dyes is measured, and the amount of background light is also measured.

The level of expression of a gene, or genetic expression, is set forth in relative terms, which is to say that in a first particular circumstance (sample) a gene is expressed either more or less than a second particular circumstance (reference). For example, a gene may be expressed more in children than in adults, or the other way around. It may also be expressed differently in a person with a disease than in a healthy individual. This is because the cells that the genes are in operate differently in different circumstances.

The term up regulation means that a gene is more abundant in the sample than in the reference and down regulation means that a gene is less abundant in the sample than in the reference. Thus, one discusses the level of expression for a gene in sample A versus the level of expression of a gene in sample B.

These relative levels of genetic expression in samples can be assayed using cDNA arrays. The comparative level of gene expression for a given gene in sample A relative to sample B is can be expressed as the ratio of the background-subtracted intensities of fluorescence of the gene spot exposed to sample A divided by the background-subtracted intensities of fluorescence from a gene spot exposed to sample B. A ratio greater than one (e.g. log 2>0) implies up-regulation of the gene in sample A as compared with B.

### 3. THE DATASETS AND RATIONALE

In the examples disclosed here, background-subtracted spot intensities are sorted in ascending order to assign a rank to every spot. For instance, in a system where the higher number in the spot order means a higher intensity, a spot whose rank is 3000 has a higher background subtracted spot intensity than all spots whose ranks are <3000. A system where the lowest number corresponds to the highest intensity would be equivalent in practice. A microarray Spot Order (labeled “SO” in the drawings) is a listing of its spots sorted by their ranks. A cDNA spotted slide generates two spot orders, the first dye spot order (“SO1”) and the second dye spot order (“SO2”), which correspond to spot orders of the genes of samples labeled with the first and second dyes, in the exemplary case Cy3 and Cy5 respectively.

Datasets can be taken in such a way as to assure that the measurements taken comport with good scientific experimental design. Thus, a system of blanks and controls is used. In a ‘blank’ there is a true negative dataset—a dataset where there is known to be no true expression within the data. A control has a known level of positive response. The true negative datasets compare the same pool of brain RNA with itself (same-to-same), so that there should be no up or down expression relative to itself The goal of the same-to-same comparisons is to collect experimental noise (technical artifacts) independent of biological heterogeneity. In this design, normalized expression ratios≠1 (log 2≠0) are false positive (noise) because the Cy3/Cy5 symmetrical images contain identical genetic information.

The ‘artifactual’ measurements, that is measurement results that are the result on the experimental equipment instead of the experimental samples, may be caused by several factors including slide-to-slide differences, variations in the reverse transcription reactions, hybridization, labeling and laser. In the present exemplary embodiment, the same-to-same comparisons include 18 and 20 experiments that generate a total of 9 and 10 dye swapping datasets using the human 1.7K and 19K microarrays, respectively. The experiments are paired by consecutive order. The new algorithm operates to filter same-to-same expression ratios originating from technical noise. Compared with MASH, the new algorithm discovers a smaller number of genes as being differentially expressed in the same-to-same design.

The exemplary 1.7K microarray includes 64 genes of Arabidopsis cDNA. True positive datasets can include four sets of spike-in dye swapping experiments using exemplary 1.7K microarrays, where 1 ng of Arabidopsis RNA is added to one sample but not the other. Thus, in the spike-in samples, there is sample Arabidopsis cDNA to hybridize with the probe Arabidopsis cDNA. In this design, all 64 genes of probe Arabidopsis cDNA serve as true positives. The sensitivity of MASH is 26/64 [41%, (Fathallah-Shaykh et al., 2004)]. The new algorithm discovers all 64 Arabidopsis genes as being differentially expressed.

### 4. MASH SUMMARY

The present invention is somewhat related to the prior MASH filter, so the two are explained relation to each other in the following. MASH includes two filters, F1 and F2. A spot is sensitive to F1 if both its symmetrical ranks in the first dye spot order and the second dye spot order are less than a predetermined cutoff rank. To be resistant to F1, either Cy3 or Cy5 images of the spot must contain enough signals such that at least one of the symmetrical ranks is larger than the cutoff rank. The latter is computed empirically from the slopes of the ranking curves (Fathallah-Shaykh et al., 2004).

The second filter (F2) of MASH consists of two rules. The first Rule (named either F2a or f4) is that all four replicate ratios consistently show up or down-regulation; i.e. all four replicate log 2 (ratios)>0 or all four <0. The second Rule of F2 (F2b) necessitates that all four replicate F2b-resistant log 2 (ratios) must be outside a predetermined number of standard deviations from a mean. In the exemplary embodiment of the interval of +3 times the largest of the standard deviations of all F1-resistant log 2 (ratios). Genes sensitive to either f4 or F2b are filtered by trans-forming their mean log 2 (ratio) to 0.

### 5. THE EFFECTS OF THE TWO FILTERS, MASH AND FS

The experience is that microarray datasets are heterogeneous (FIGS. 1-3). This heterogeneity is reflected by their geometrical structure in the 3 dimensional space, whose axes are the ranks in the first dye spot order and the second dye spot order and the log 2 (ratios). Specifically, this geometry/distribution (1) is unique to each dataset (FIGS. 1 and 3), (2) includes a zone of instability, whose F1-sensitive spots generate large errors (FIG. 1-3), and (3) displays rank-dependent variability of log 2 (ratios). Accordingly, the 19K dataset looks something like a butterfly in 3 dimensions, and 1.7 k dataset looks something like a cone with a tail.

The f4-sensitive spots intrinsic to each dataset (1) replicate the geometry/distribution of all spots in the dataset (FIGS. 1 and 3) and (2) are independent of the genes that are differentially expressed. Accordingly, this new algorithm constructs rank-dependent upper and lower bound contour surfaces that are patterned based on the geometrical structure of f4-sensitive spots (FIG. 4). The zone of instability is generated by ratios whose ranks are both less than the cutoff rank. This finding is consistent with, but not specified by, the results of Baggerly et al. (2001) who report that ratios computed from spots containing a small amount of total signal are highly variable, whereas ratios derived from spots containing large amount of total signal are fairly stable. The zone of instability (FIGS. 1-3) may also explain the results of Tan et al. (2003) who demonstrate poor reproducibility of states of genetic expression across different platforms.

Sensitivity is a function of measurable quality parameters; specifically, it is negatively correlated with the Noise Factor (Fathallah-Shaykh et al., 2004). In addition, poor data quality has a negative impact on the efficient detection of low-level regulated genes (Raffelsberger et al., 2003). Specifically, the distributions of false positive ratios vary between datasets; poor quality datasets contain large false positive ratios (Fathallah-Shaykh et al., 2004).

Therefore, the degree of confidence that a low- or moderate-level expression ratio is true is dependent, not only on the analytical methods, but also on the unique distribution of noise in that specific dataset. Thus, to annul the confounding effects of data quality on sensitivity, the true positives of this study are designed to represent large differentials generated by adding Arabidopsis RNA to one sample but not the other. The specificity and sensitivity of the algorithm appear to be best at n=3 for the specific system studied. Values of n>3 yield lower sensitivity (FIG. 6c) and values of n<3 yield lower specificity (FIGS. 6a and b). The z-axis positions of the contour surfaces are dependent on the standard deviation of the local (neighborhood) noise isolated by the square columns at specific ranks. The assays developed in this paper leads to a test (Fs) that compares the geometrical structures of distributions in the 3D space. Specifically, Fs divides the space into small subspaces (neighborhoods) and constructs contour surfaces whose z-axis variance is based on the local distributions at specific ranks (FIG. 4).

The position of the cutoff rank of the first filter of MASH, F1, is stochastic (Fathallah-Shaykh et al., 2004). Notice that F1 filters the zone of instability (FIGS. 1-3). It is not surprising that Fs is more sensitive than F1 (FIG. 6c); specifically, instead of deleting the zone of instability, Fs generates upper- and lower-bound contour surfaces around it (FIGS. 1, 2 and 5).

Unlike other methods this analysis is not dependent on (1) assuming linearity in the error model, (2) correlating levels of transcripts to signal levels, or (3) addressing the question of accuracy of fold-changes in gene expression (Newton et al., 2001; Theilhaber et al., 2001; Yang et al., 2002; Huber et al., 2002; Goryachev et al., 2001; Bolstad et al., 2003; Irizarry et al., 2003).

The present method determines the genes that are up or down regulated between the samples to a high degree of certainty. The results that follow reveal that the geometrical distributions of f4-sensitive spots (noise) in the 3D space are non-linear (FIGS. 1-3). Nonetheless, because the distribution of f4-sensitive spots models the distribution of all spots in the dataset (FIGS. 1 and 3), the algorithm builds contour upper- and lower-bound surfaces based on the distributions of f4-sensitive spots (FIGS. 4 and 5). Herein, the datasets are normalized by the non-linear method described in more detail elsewhere (Fathallah-Shaykh et al., 2004).

Each spot generates two measurements of the total intensity within the spot and the local background intensity defined as the total intensity within a small rim surrounding the spot. The background-subtracted spot intensities (y-axis) versus spot ranks (x-axis) of a dataset are acquired from the microarrays.

Normalization of data can be done. In one method of normalization, a log trans-formation of the dataset is done. The log transformed dataset is curve-fitted to:

$$f ( x ) = \begin{matrix}\begin{matrix}( \frac{{a}_{1} * x}{x + {a}_{2}} + \frac{x}{ns - x + {a}_{3}} - {a}_{4} ) * \\ {a}_{5} * ( \frac{1}{1 + {( {a}_{7} / x )}^{{a}_{6}}} + \frac{{a}_{8}}{1 + {( {a}_{10} / x )}^{{a}_{9}}} - \frac{{a}_{11}}{x + {a}_{12}} ) *\end{matrix} \\ ( 1 + \frac{{a}_{13}}{1 + {\vert 1 - ( {a}_{15} / x ) \vert}^{{a}_{14}}} ) + ( \frac{1}{1 + {( {a}_{17} / x )}^{{a}_{16}}} - {a}_{18} ) * {a}_{19}\end{matrix}$$

where x refers to rank, ns refers to the total number of spots in the array; ns=3840 for the 1.7K microarrays, and parameters (a1, . . . , a19) vary between individual curves.

Colantuoni et al. (2002) have also described methods for local normalization by non-linear transformations. Fs is applicable to 2-color (2-channel) microarray data with dye swapping replicates. Highly specific discovery of states of genetic expression has immediate and numerous applications; specifically, it generates testable hypotheses in biology and medicine that uncover molecular systems behind biological phenotypes. Examples include the phenotypes of resistance to oxidative stress and motility in cultured glioma and ectopic calcification in meningioma (Fathallah-Shaykh et al., 2003; Fathallah-Shaykh, 2005a,b).

### 6. SAMPLES, MICROARRAYS, AND EXPERIMENTAL METHODOLOGY

A source of sample RNA is needed for a gene microarray experiment. For the present explanation of the invention, and the examples that follow, the underlying experiments were done with normal brain RNA obtained by pooling RNA from human occipital lobes harvested from four individuals with no known neurological disease whose brains are frozen <3 h post mortem. Tumor RNAs, isolated from 35 surgical gliomas, 10 surgical meningiomas and 6 cultured glial cell lines, are profiled as compared with aliquots from the same normal brain RNA (Fathallah-Shaykh et al., 2003, 2002, 2004; Fathallah-Shaykh, 2005a). The quality of RNA can be assayed by gel electrophoresis, and in the present exemplary embodiment only high quality RNA is processed.

The microarray probes used in the present embodiment are microarray slides with 1.7K (1920 genes) and 19K (19 200 genes) microarrays containing cDNAs spotted in duplicates, the microarrays having been obtained from the Ontario Cancer Institute in Ontario, Canada. Other slides may be used, and as long as the same genes are tested across replicates, whether one or more slides is used for each of the replicates is, in theory, immaterial. Naturally, using identical slides from an identical source is preferred in order to improve reproducibility.

### 7. HETEROGENEOUS GEOMETRICAL DISTRIBUTIONS OF NOISE

The same-to-same datasets comprise errors in measurement generated by technical noise. FIGS. 1a and d plot the distributions of same-to-same 19K and 1.7K microarray datasets in the 3D space defined by (1) ranks in the first dye spot order (x-axis), (2) ranks in the second dye spot order (y-axis), and (3) log 2 (ratios) (z-axis), respectively. If the experimental system generated no noise, the z-axis coordinates would all be equal to 0. Large positive or negative log 2 (ratios) reflect large errors indicated with arrows labeled 10.

The findings presented in FIG. 1 reveal that the distributions of noise in the 3D space are heterogeneous because each microarray dataset generates its unique geometrical structure, which differs between datasets. Specifically, the z-axis variations of log 2 (ratios) about 0 are rank-dependent and unique to a specific dataset (FIG. 1, arrows labeled 20).

The analysis of the present invention provides techniques for permitting the automation of dealing with the unique geometrical structure of each data set. If the unique geometrical structure of the data is thought of as being analagous to a mathematical manifold. The techniques of the present invention provide something akin to a local geometry on the manifold that is homeomorphic with the manifold. The localization that results permits defining a noise geometry that tracks the unique geometry of the data set.

### 8. ZONE OF INSTABILITY

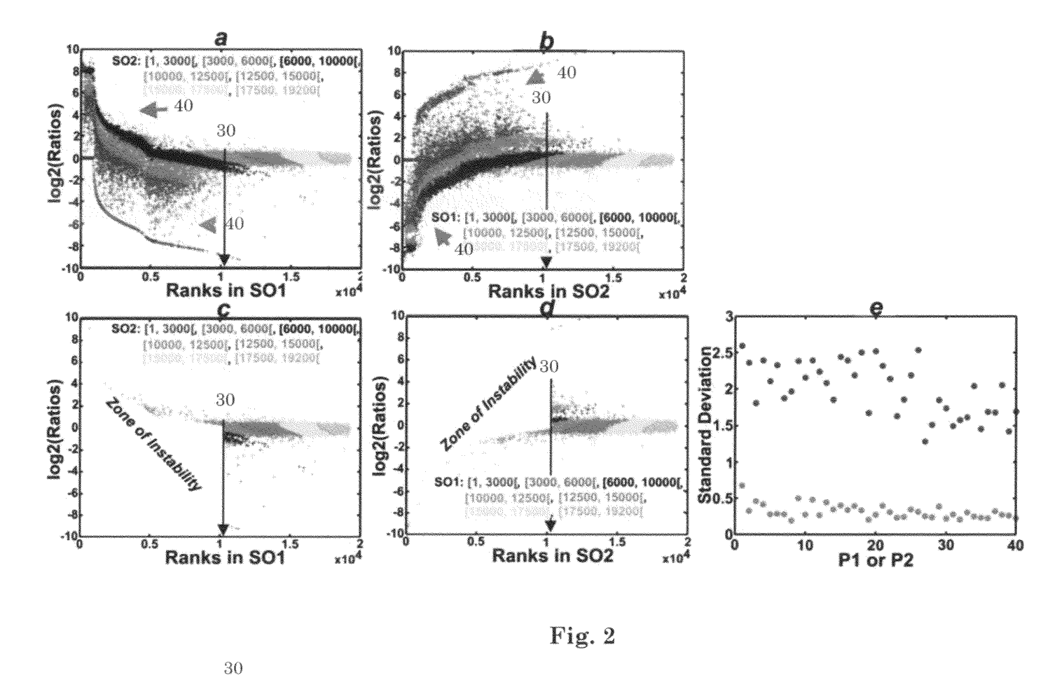

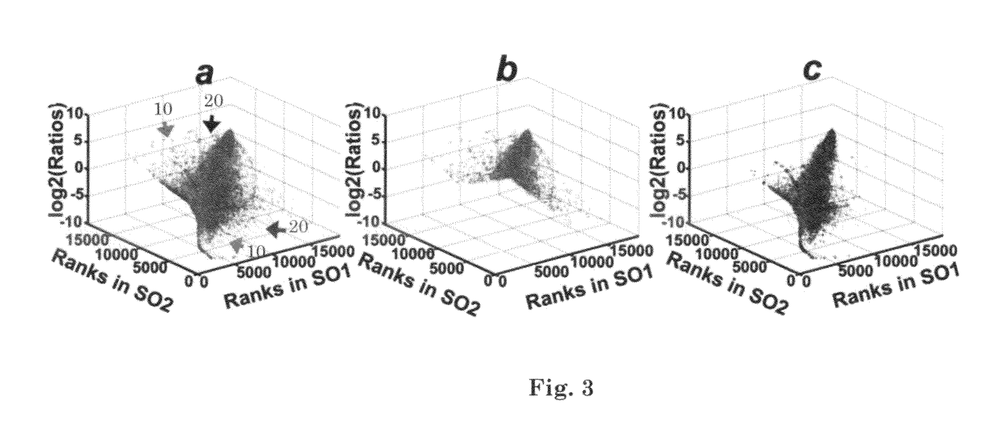

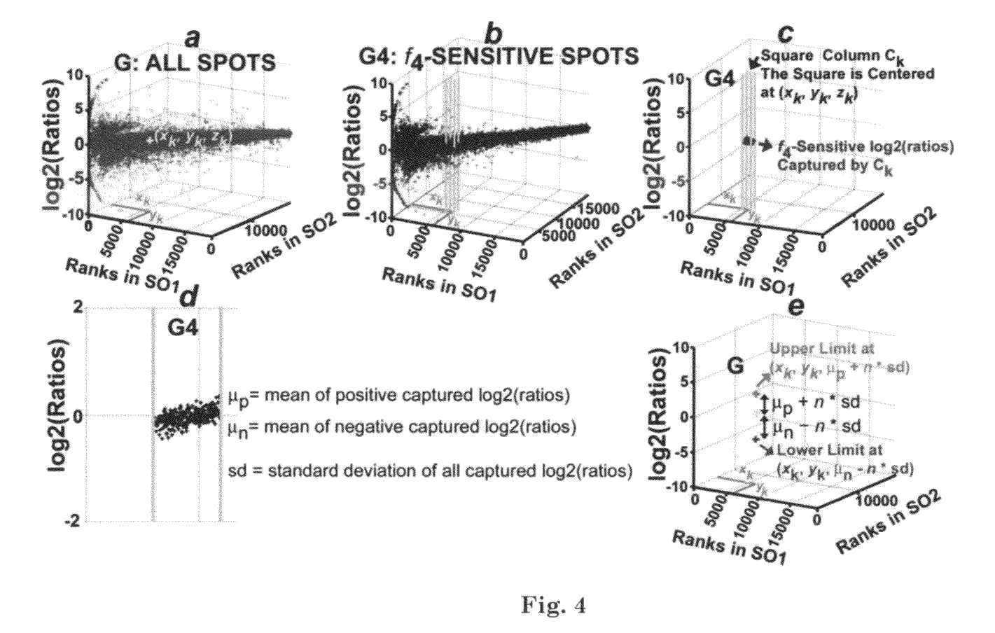

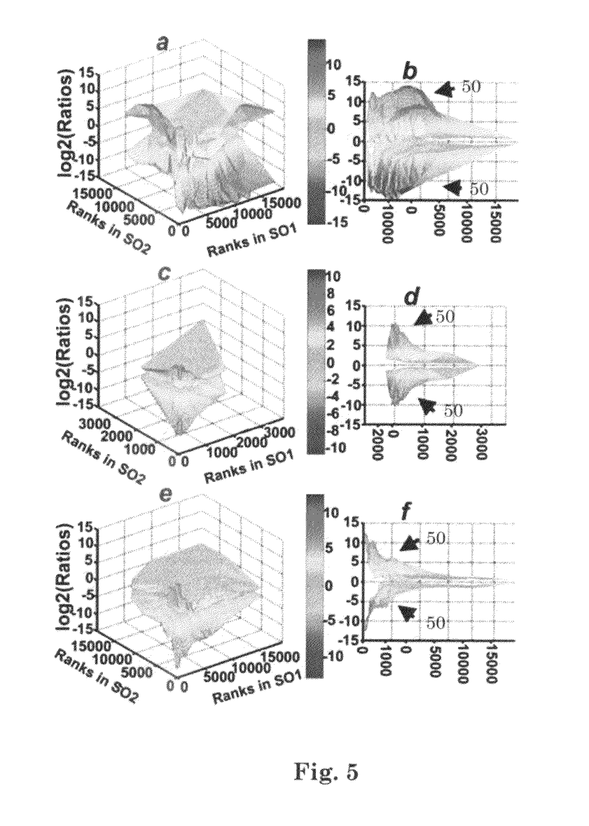

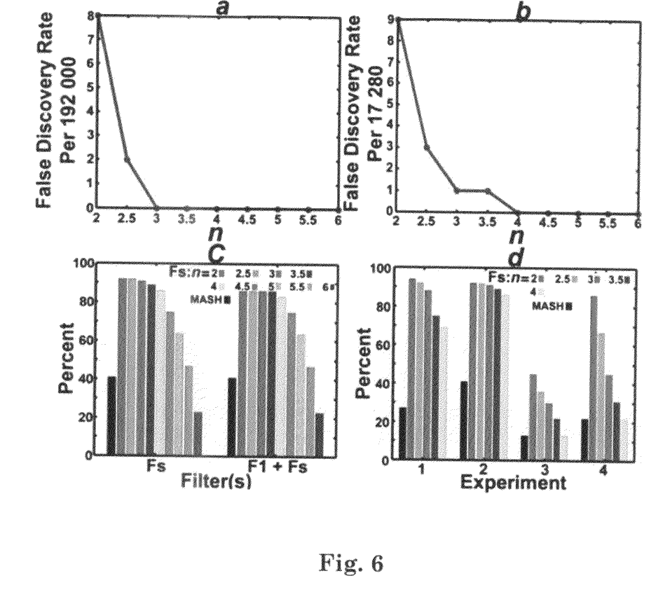

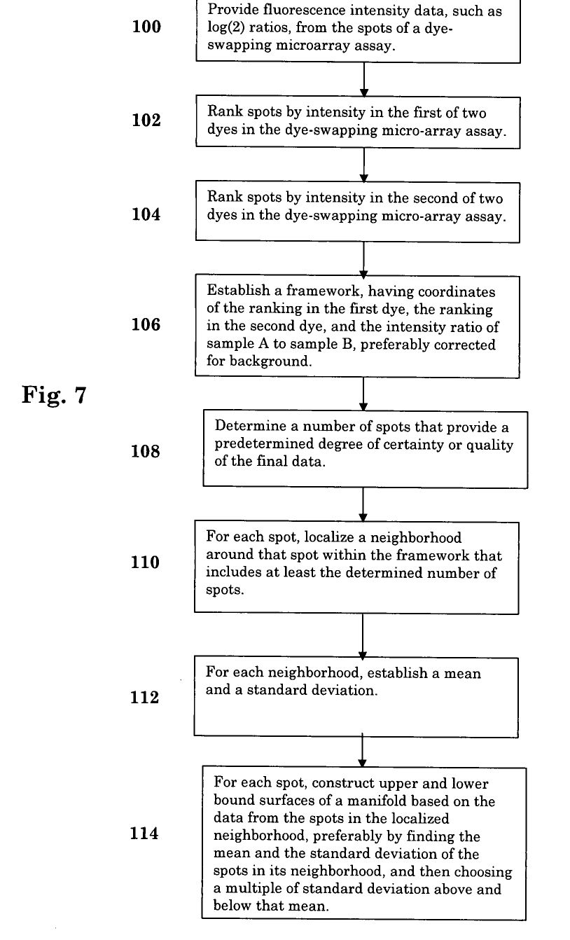

FIGS. 1a and 1d of exemplary sorted data show that the distributions in the 3D space include zones of instability where the log 2 (ratios) have large absolute values (arrows 10). FIG. 2a plots the projections of the distribution of noise of FIG. 1a onto the 2D space defined by ranks in the first dye spot order (x-axis) and log 2 (ratios) (y-axis). FIG. 2b plots the projections of the distribution of noise of FIG. 1a onto the 2D space defined by ranks in the second dye spot order (x-axis) and log 2 (ratios) (y-axis), respectively. To visualize the rank-dependent behavior of noise, the spots are colored by their ascending ranks (FIG. 2). As in FIG. 1a, FIGS. 2a and 2b also reveal that the distributions of noise include zones of instability, where log 2 (ratios) have large values (large errors; arrows 10).

FIGS. 1 and 2 suggest that the zone of instability is dependent on the ranks in both the first dye spot order and the second dye spot order. For example, the spots of FIGS. 2a and 2b whose ranks in the first dye spot order and the second dye spot order are both <10,000 generate unstable or large log 2 (ratios). The number 10,000 is unique to the dataset plotted in FIG. 2; other datasets may be associated with different ranks.

Since the first filter of MASH (F1) excludes spots whose ranks in the first dye spot order and the second dye spot order are both smaller than the cutoff rank, the question arises whether F1 defines the zone of instability. A spot is resistant to F1 if either one of its ranks in either the first dye spot order or the second dye spot order is larger than the cutoff rank. To understand the effects of F1 on the zone of instability, it is applied to filter the data shown in FIGS. 1a, 1d, 2a and 2b. FIGS. 1b and e plot the log 2 (ratios) of F1-resistant spots of FIGS. 1a and d, respectively. FIGS. 2c and d plot the log 2 (ratios) of F1-resistant spots of FIGS. 2a and 2b, respectively.

The data illustrated in FIG. 2e reveals that the standard deviations of F1-sensitive log 2 (ratios) (blue; spots filtered by F1) are 5-10 folds larger than F1-resistant log 2 (ratios) (green; spots not filtered by F1). The findings support the conclusions that (1) spots whose symmetrical ranks are both less than the cutoff rank generate a zone of instability containing large errors of measurement [large absolute log 2 (ratios)], and (2) F1 filters the zone of instability.

### 9. MATHEMATICAL MODELING OF NOISE

The effects of F1 on the distributions of different-to-different datasets is considered. As in the geometrical distributions of same-to-same datasets, the distributions of the different-to-different datasets (1) are heterogeneous between datasets and rank-dependent, and (2) include F1-sensitive zones of instability (FIG. 3). However, unlike the same-to-same design, where any log 2 (ratio) different than 0 is false positive, the distinction between true and false positive ratios in different-to-different comparisons is not evident.

FIGS. 2 and 3 demonstrate that F1 deletes the zone of instability, which includes a large portion of the data. The goal of the next section is to detail a method that models the noise intrinsic within each dataset in such a way that the method (1) is applicable to all datasets despite their heterogeneity (FIG. 1), and (2) contours the zone of instability instead of deleting it.

### 10. GEOMETRICAL FILTER FS

In order to identify noise data in relation to the unique geometrical data distribution in a dataset it is desirable to demark a boundary that can define a separation between signal and noise. If one considers the noise portions (errors of measurements) of the dataset to be analagous to a manifold, it would be useful to be able to use the local geometrical structure of a sample of the noise data to define the demarcation between signal (true) and noise (false). Therefore, mathematical operations are useful if they can operate at least approximately homeomorphically in local regions/neighborhoods to define local filters that can be assembled to act on a larger manifold.

The filter f4 (F2a) was devised in the glioma study (Fathallah-Shaykh et al., 2002). A gene is resistant to f4 if its four replicate log 2 (ratios) are all positive or all negative (consistently showing up or down regulation). A gene is sensitive to f4 if all four replicate log 2 (ratios) are not of the same sign. Because the false negative rate of f4 is only 1.6%, the predominant majority of f4-sensitive spots are false positive or noise. The filter f4 therefore can assist in defining noise to provide: 1) the desired localization to the geometrical distribution of all the data, and 2) a 3-manifold that can be used to build the local filters.

FIGS. 1c, 1f and 3c plot the f4-sensitive spots of the datasets shown in FIGS. 1a, 1d and 3a, respectively. Interestingly, the findings demonstrate that the geometrical distribution of f4-sensitive spots (or the kernel of the function f4) replicates the unique geometrical distribution of all the spots in the dataset. This is not surprising considering that (1) in same-to-same experiments any log 2(ratio) different than 0 is false positive, and (2) only a small fraction of different-to-different datasets is truly differentially expressed. Most importantly, because the geometrical structures/distributions created by f4-sensitive noise are independent of the spots that are truly differentially expressed, they serve as a platform for constructing a new filter.

Each dataset generates two geometrical structures in the 3D spaces generated by the log 2 (ratios) of (1) all the spots (FIGS. 1a, d and 3a), and (2) the f4-sensitive spots (spots filtered by f4; FIGS. 1c, f and 3c). The distribution of the latter represents noise intrinsic to each dataset. In reality, the two distributions are interwoven in the same space. However, for practical purposes, the spaces/geometrical distributions of all spots in the dataset and f4-sensitive spots (kernel) will be referred to as G and G4, respectively (FIGS. 4a and 4b).

The rationale of the new filter (Fs) is that a method that filters all f4-sensitive spots in G4 (G4, see FIG. 4b), when applied to G, will lead to a high degree of certainty that the unfiltered spots of G are true (FIG. 4a). Fs comprises upper and lower bound contour surfaces that are patterned based on the geometrical structure of G4. These contour surfaces set the upper and lower bound z-axis limits at specific ranks such that any spot of G that maps outside these bounds is true to a high degree of certainty. Therefore they are upper and lower surfaces of the demarcation of signal to noise that defines the manifold through a series of localizations.

Referring to FIG. 7, the geometrical structures in G and G4 consist of spots whose x-, y- and z-axis coordinates are integer ranks in the first dye spot order 102, the second dye spot order 104 and log 2 (ratio) 100 respectively (FIGS. 1-4). Accordingly, the xy space is divided into a grid, xy grid element defining a columnar space for z. For every spot k of coordinates (xₖ, yₖ, zₖ) in G (FIG. 4a), the algorithm applies a neighborhood. The neighborhood defines a two-dimensional shape to the xy plane of the three dimensional space, such as a square or circle, to define a two-dimensional region. While the manifold may be defined in terms of a set of rectangular localizations as given here, the localizations may be of any shape. Those of ordinary skill in the art could apply neighborhoods of different shape, for example, making the localization round, such as a circle or ellipse, rather than a square or rectangular.

The neighborhood as seen in the example is a four sided-column (Cₖ), preferably a square column, within G4 such that (1) the column is parallel to the z-axis, and (2) the center of the square maps at the coordinates (xₖ, yₖ, zₖ) (FIG. 4b). The column can extend in both the y and x directions, preferably the same amount on both axes. Since the log 2 (ratios) of the spots present within each column reflect the local variability of noise at ranks xₖ and yₖ, they are isolated and their standard deviation and the means of the positive and negative log 2 (ratios) are computed (FIGS. 4c and d).

In order to obtain valuable averaging, the square column should contain multiple points. In one embodiment of the present invention, a computer is programmed with an algorithm that increases the size of the rectangular column, preferably as a square, until it includes a minimum number of spots. In one embodiment of the invention this minimum number of spots is 100 spots. The optimal number of spots isolated by Cₖ is varied and computed empirically when the algorithm is completed; experience with a limited number of datasets leads to the belief that about 100 spots provides a low false discovery rate. Those of ordinary skill in the art will appreciate that this number might be different for different applications of the technique.

Now that a plurality of points have been defined, a model distribution can be selected and applied. Those of ordinary skill in the art are familiar with many distributions, but for the purposes of example, a normal distribution model is selected. Other possible distributions include, but are not limited to, symmetric distributions of the continuous or discrete kinds, such as a binomial distribution or a Poisson distribution. Those of ordinary skill in the art understand that model distributions can have model distribution parameters that describe the distribution. In the case of a normal distribution, a normal distribution is usually described in terms of its mean and standard deviation, and that this mean and standard deviation relate to the statistical significance (or confidence level) of values a certain number of standard deviations from the mean. The example that follows is based on a normal distribution model.

Let sd be the standard deviation of all log 2 (ratios) isolated by column Cₖ. Let μₚ and μₙ be the means of their positive an negative log 2 (ratios), respectively (FIG. 4d). At every spot of coordinates (xₖ, yₖ, zₖ) in G, the upper and lower limits are set at spots in G having the following coordinates:

(1) An upper-bound limit at (xₖ, yₖ, μₚ+n*sd).

(2) A lower-bound limit at (xₖ, yₖ, μₙ−n*sd).

The term n is a variable (FIG. 4e), that is not necessarily an integer. The upper and lower bound limits computed from all the spots of G assemble the upper and lower bound surfaces (FIG. 5). Fs applies the following rules:
A spot is filtered if its log 2 (ratio) maps within the 3D space bound by the upper and lower contour surfaces. Alternatively, a spot is resistant if its log 2 (ratio) maps above the upper-bound surface or below the lower-bound surface.
A gene is resistant if all of its four replicate spots are resistant to the rule above. A gene is sensitive to the filter if any of its replicate spots are sensitive. The log 2 (ratio) of a sensitive gene is transformed to 0.

At this stage, the method makes the assumption of the existence of contour surfaces such that (1) the 3D space, limited by the upper- and lower-bound surfaces includes the overwhelming majority of noise, and (2) the log 2 (ratios) that map above or below the upper- and lower-bound surfaces, respectively, are true. The z-axis positions of the contour surfaces and the 3D space between them are dependent on (1) n, (2) μₚ, μₙ and sd. Experience is that the z-axis coordinates and 3D space between the contour surfaces are larger over the zone of instability (FIG. 5, arrows) because of the large standard deviations of its log 2 (ratios) (FIG. 2e).

In theory, the variable n determines both specificity and sensitivity. For example, if n is ‘very large’ (e.g. about 4 or more), one expects sensitivity to be low because (1) the z-axis limits of the contour surfaces will also be large, and (2) the space between the contour surfaces will include all log 2 (ratios). However, if n is ‘small’ (e.g. about 1 or less), specificity could be low because the contour surfaces may not include all the noise. The goal is to find a value of n that yields optimal specificity and sensitivity. Specificity will be assayed as 1—the false discovery rate of Fs in same-to-same comparisons. Ideally, Fs should filter all same-to-same log 2 (ratios). Sensitivity will be assayed by percent discovery of Arabidopsis genes in different-to-different spikein experiments (see above). Ideally, Fs should discover all the Arabidopsis genes.

### 11. OPTIMIZING N AND COMPARING THE SENSITIVITY AND SPECIFICITY OF FS TO MASH

Now to compare the specificity of MASH to Fs while varying n within the interval [2, 6]. MASH consists of F1+f4 (F2a)+F2b. The false discovery rate is computed from nine 1.7K and ten 19K same-to-same experiments (FIGS. 6a and b). The results reveal that the specificity of Fs alone is as high as MASH for n≧3 (FIGS. 6a and b and Table 1).

Sensitivity is assayed by the percentage of Arabidopsis genes discovered from the best of four replicate spike-in experiments, where 1 ng Arabidopsis RNA is added to one RNA sample but not the other (FIGS. 6c and d). The following filter combinations are applied: (1) Fs alone, and (2) F1 and Fs (FIG. 6c). As compared with MASH, Fs improves the best sensitivity from 41 to 91% at n=3. However, adding F1 and f4 to Fs lowers the sensitivity to 86% at n=3. In addition, FIG. 6d demonstrates that, as compared with MASH, the increase in sensitivity of Fs at n=3 is statistically significant in all four replicate spike-in experiments (P=0). These findings support the conclusion that Fs at n=3 significantly improves sensitivity without lowering the high specificity of MASH. Receiver Operating Characteristics (ROC) is the standard approach to evaluate the sensitivity and specificity of diagnostic procedures (Swets and Pickett, 1992). MASH and Fs at n=2, 2.5 and 3 generate the empiric ROC areas of 0.703, 0.96, 0.96 and 0.95, respectively. The accuracy rates are 99.8%, 99.9%, 100% and 100%, respectively (Table 1). Fs is also applied to analyze four same-to-same datasets of Rosenzweig et al. (2004). Each dataset includes 710 ‘genes’ spotted in duplicates to a total of 1420 spots. The false discovery rates per 2840 genes are 4, 2 and 0 at n=2, 4 and 3-6, respectively. The findings demonstrate that Fs is also effective in filtering the noise of datasets acquired in independent laboratories.

### 12. EXAMPLE 1

To test the algorithms, Fs, MASH and MIDAS were applied to analyze the same datasets. The specificity of Fs at n=3 is similar to MASH (Table 1 and FIG. 6), whose specificity is significantly better than MIDAS (Fathallah-Shaykh et al., 2004). MIDAS includes the Locfit

TABLE 1

| | | | Sensitivity | | |
|---|---|---|---|---|---|
| | Same-to-same false | | (%) | Empiric | Accuracy |
| | discovery rate | | 1.7K | ROC Area | (%) |
| | 19K | 1.7K | Spike-in | 1.7K | 1.7K |
| MASH | 1/192,000 | 1/17,280 | 41 | 0.703 | 99.8 |
| Fs: n = 2 | 8/192,000 | 9/17,280 | 92 | 0.96 | 99.9 |
| Fs: n = 2.5 | 2/192,000 | 3/17,280 | 92 | 0.96 | 100 |
| Fs: n = 3 | 0/192,000 | 1/17,280 | 91 | 0.95 | 100 |

Fs at n=3 significantly improves sensitivity without lowering the high specificity of MASH n is described in the definition of Fs. The same-to-same false discovery rates are computed from 10 dye-swapping 19K and 9 dye swapping 1.7K datasets that compare brain RNA to itself. The false discovery rate of the same-to-same design equals the number of false positive ratios. Thus specificity is measured as 1—same-to-same false discovery rate.

The false discovery rate of Fs at n=3 is similar to MASH. Percent sensitivity refers to the best sensitivity of four replicate spike-in dye swapping 1.7K datasets, where 1 ng of Arabidopsis RNA is added to one sample but not the other. Each 1.7K microarray includes 64 Arabidopsis genes.

The sensitivity of Fs at n=3 is 91%, more than double the sensitivity of MASH. ROC estimates a curve, which describes the inherent tradeoff between sensitivity and specificity of a diagnostic test. The area under the ROC curve is important for evaluating diagnostic procedures because it is the average sensitivity over all possible specificities (Swets, 1979; Metz, 1986; Obuchowski, 2003). Eng, J. (n.d.). ROC analysis: web-based calculator for ROC curves. Retrieved (May 23, 2005), from URL: www.rad.jhmi.edu/roc. (LOWESS) normalization (Quackenbush, 2002; Yang IV et al., 2002), standard deviation regularization (Yang Y H et al., 2002), iterative linear regression normalization (Quackenbush, 2002), iterative log mean centering normalization (Causton et al., 2003), ratio statistics normalization and confidence interval checking (confidence range at 99%) (Chen et al., 1997), standard deviation regularization, low intensity filter, slice analysis (Quackenbush, 2002; Yang I V et al., 2002), and flip dye consistency checking (Yang Y H et al., 2002; Quackenbush, 2002).

### 13. REFERENCES

Baggerly, K. et al. (2001) Identifying differentially expressed genes in cDNA microarray experiments. J. Comput. Biol., 8, 639-659.
Bolstad, B. M. et al. (2003) A comparison of normalization methods for high density oligonucleotide array data based on variance and bias. Bioinformatics, 19, 185-193.
Causton, H. C., Quackenbush, J. and Brazma, A. (2003) Microarray Gene Expression Data Analysis: A Beginner's Guide. Blackwell Publishing, pp. 55-56.
Chen, Y. et al. (1997) Ratio-based decisions and the quantitative analysis of cDNA microarray images. J. Biomed. Optics, 2, 364-374.
Colantuoni, C. et al. (2002) SNOMAD (Standardization and Normalization of Microarray Data): web-accessible gene expression data analysis. Bioinformatics, 18, 1540-1541.
DeRisi, J. L. et al. (1997) Exploring the metabolic and genetic control of gene expression on a genomic scale. Science, 278, 680-686.
Fathallah-Shaykh, H. M. (2005a) Genomic discovery reveals a molecular system for resistance to ER and oxidative stress in cultured glioma. Arch. Neurol., 62, 233-236.
Fathallah-Shaykh, H. M. (2005b) Logical networks inferred from highly specific discovery of transcriptionally regulated genes predict protein states in cultured gliomas. Biochem. Biophys. Res. Comm., 336, 1278-1284.
Fathallah-Shaykh, H. M. et al. (2002) Mathematical modeling of noise and discovery of genetic expression classes in gliomas. Oncogene, 21, 7164-7174.
Fathallah-Shaykh, H. M. et al. (2003) Genomic expression discovery predicts pathways and opposing functions behind phenotypes. J. Biol. Chem., 278, 23830-23833.
Fathallah-Shaykh, H. M. et al. (2004) Mathematical algorithm for discovering states of expression from direct genetic comparison by microarrays. Nucleic Acids Res., 32, 3807-3814.
Goryachev, A. B. et al. (2001) Unfolding of microarray data. J. Comp. Biol., 8, 443-461.
Huber, W. et al. (2002) Variance stabilization applied to microarray data calibration and to the quantification of differential expression. Bioinformatics, 18, S96-S104.
Irizarry, R. A. et al. (2003) Exploration, normalization, and summaries of high density oligonucleotide array probe level data. Biostatistics, 4, 249-265.
Kothapalli, R. et al. (2002) Microarray results: how accurate are they? BMC Bioinformatics, 3, 22.
Lockhart, D. J. et al. (1996) Expression monitoring by hybridization to high density oligonucleotide arrays. Nat. Biotechnol., 14, 1675-1680.
Metz, C. E. (1986) Methodology in radiologic imaging. Invest. Radiol., 21, 720-733.
Newton, M. et al. (2001) On differential variability of expression ratios: improving statistical inference about gene expression changes from microarray data. J. Comp. Biol., 8, 37-52.
Ntzani, E. E. and Ioannidis, J. P. (2003) Predictive ability of DNA microarrays for cancer outcomes and correlates: an empirical assessment. Lancet, 362, 1439-1444.
Obuchowski, N. A. (2003) Receiver operating characteristic curves and their use in radiology. Radiology, 229, 3-8.
Quackenbush, J. (2002) Microarray data normalization and transformation. Nat. Genetics, 32 (Suppl.), 496-501.
Raffelsberger, W. et al. (2003) Quality indicators increase the reliability of microarray data. Genomics, 80, 385-394.
Rosenzweig, B. A. et al. (2004) Dye bias correction in dual-labeled cDNA microarray gene expression measurements. Environ. Health Perspect., 112, 480-487.
Schena, M. et al. (1995) Quantitative monitoring of gene expression patterns with a complementary DNA microarray. Science, 270, 467-470.
Swets, J. A. (1979) ROC analysis applied to the evaluation of medical imaging techniques. Invest. Radiol., 14, 109-121.
Swets, J. A. and Pickett, R. M. (1992) Evaluation of Diagnostic Systems: Methods from Signal Detection Theory. New York: Academic Press.
Tan, P. K. et al. (2003) Evaluation of gene expression measurements from commercial microarray platforms. Nucleic Acids Res., 31, 5676-5684.
Theilhaber, J. et al. (2001) Bayesian estimation of fold-changes in the analysis of gene expression: the PFOLD algorithm. J. Comp. Biol., 8, 585-614.
Yang, I. V. et al. (2002) Within the fold: assessing differential expression measures and reproducibility in microarray assays. Genome Biol., 3, research0062.
Yang, Y. H. et al. (2002) Normalization of CDNA microarray data; a robust composite method addressing single and multiple slide systematic variation. Nucleic Acids Res., 30, e15.

1. A method of improving the sensitivity and selectivity of dye swapping cDNA microarray assays comprising:
providing replicate expression data for sample genetic material and reference genetic material for a plurality of probe genetic materials, the replicate expression data comprising intensities of fluorescence from a first dye and a second dye, the replicate expression data comprising a first set of fluorescence measurements having the first dye labeling the sample genetic material and the second dye labeling the reference genetic material, and the replicate expression data comprising a second set of fluorescence measurements having the second dye labeling the sample genetic material and the first dye labeling the reference genetic material;
ranking the replicate expression data based on the intensity of fluorescence from the first dye to generate a first spot order ranking for each expression datum;
ranking the replicate expression data based on the intensity of fluorescence from the second dye to generate a second spot order ranking for each expression datum;
establishing a three-dimensional framework that has indices of first spot order ranking, second spot order ranking, and the ratio of the fluorescence intensity of the dye labeling the sample genetic material to the fluorescence intensity of the dye labeling the reference genetic material;
predetermining a level of significance for final result;
establishing an upper surface and a lower surface in the three dimensional framework containing between them a noise region in the three dimensional framework, the noise region containing replicate expression data that have been determined as being probable noise;
removing from the replicate expression data that lies in the probable noise region of the three dimensional framework to produce data having the predetermined significance level.

2. A method of improving the sensitivity and selectivity of dye swapping cDNA microarray assays as in claim 1, further comprising:
predetermining a number of fluorescence measurements to control a quality of the result;
assigning for each fluorescence measurement a neighborhood in the three dimensional framework, each neighborhood comprising a two dimensional region in a two-dimensional framework defined by the indices of the first spot order ranking and the second spot order ranking, each neighborhood being sized to contain about the predetermined number of fluorescence measurements;
where the fluorescence measurements contained in each of the neighborhoods is used to establish the upper surface and the lower surface at the respective fluorescence measurement.

3. The method of claim 2, wherein the neighborhoods are rectangular columns, and the regions are rectangles.

4. The method of claim 3, wherein the domains are square columns and the regions are squares.

5. The method of claim 2, wherein each of the upper surface and the lower surface for a spot is determined by:
predetermining a model distribution, the model distribution having model distribution parameters;
predetermining a level of confidence for the result;
selecting model distribution parameters to fit the model distribution to the fluorescence measurements in the neighborhood of the spot; and
determining the points along the model distribution that achieve the predetermined level of confidence.

6. The method of claim 5, where the model distribution is a normal distribution, the model distribution parameters are mean and standard deviation, and the predetermined level of confidence corresponds with a multiple of standard deviation.

7. A method of improving the sensitivity and selectivity of dye swapping cDNA microarray experiments comprising:
providing replicate dye-swapping expression data for sample genetic material and reference genetic material ranking the replicate dye swapping expression data based on the intensity of fluorescence from the each of the dyes;
establishing a framework that has indices of first spot order ranking, second spot order ranking, and the ratio of the fluorescence intensity of the dye labeling the sample genetic material to the fluorescence intensity of the dye labeling the reference genetic material;
predetermining a level of significance for a final result;
using a localization function at a plurality of locations within the framework defined by first spot order ranking, second spot order ranking, ratio of fluorescence intensity and level of significance to construct a manifold demarking a boundary between signal data and noise data; and
removing from the replicate expression data that is defined as noise by the manifold.
